(19) United States
(12) Patent Application Publication
(10) Pub. No.: US 2016/0190710 A1
(43) Pub. Date: Jun. 30, 2016

(54) ANTENNA STRUCTURE

(71) Applicant: Wistron NeWeb Corp., HSINCHU (TW)

(72) Inventors: LIANG-KAI CHEN, HSINCHU (TW); CHIH-CHIEH YANG, HSINCHU (TW)

(21) Appl. No.: 14/881,580

(22) Filed: Oct. 13, 2015

(30) Foreign Application Priority Data
Dec. 27, 2014 (TW) 103145899

(51) Int. Cl. H01Q 21/28; H01Q 1/50; H01Q 7/06; H01Q 7/00; H01Q 1/12

(52) U.S. Cl. CPC H01Q 21/28; H01Q 7/00; H01Q 1/12; H01Q 7/06; H01Q 1/50

(57) ABSTRACT

An antenna structure includes a supporting element, a first coil structure, and a second coil structure. The supporting element has an upper surface, a lower surface, and lateral edges. The lateral edges are positioned between the upper surface and the lower surface and including at least a first lateral edge and a second lateral edge. The first coil structure is disposed adjacent to the first lateral edge of the supporting element. The second coil structure is disposed adjacent to the second lateral edge of the supporting element. The first coil structure and the second coil structure are configured to generate multi-directional side radiation.

### CROSS REFERENCE TO RELATED APPLICATIONS

This application claims priority of Taiwan Patent Application No. 103145899 filed on Dec. 27, 2014, the entirety of which is incorporated by reference herein.

### BACKGROUND OF THE INVENTION

1. Field of the Invention

The disclosure generally relates to an antenna structure, and more particularly, to an NFC (Near Field Communication) antenna structure.

2. Description of the Related Art

NFC (Near Field Communication) is also called “short-distance wireless communication”, which is a wireless communication technology used in a short-distance range. NFC allows electronic devices to perform non-contact point-to-point data transmission to each other within a 10 cm (3.9 inch) range. Since NFC operates on a relatively low frequency, the corresponding antenna element for NFC needs a longer resonant path. However, the inner space of a mobile device is limited, and therefore it becomes a critical challenge for an antenna designer to design a small-size, multi-directional radiation NFC antenna for covering the desired frequency band.

### BRIEF SUMMARY OF THE INVENTION

In a preferred embodiment, the disclosure is directed to an antenna structure including a supporting element, a first coil structure, and a second coil structure. The supporting element has an upper surface, a lower surface, and lateral edges. The lateral edges are positioned between the upper surface and the lower surface and include at least a first lateral edge and a second lateral edge. The first coil structure is disposed adjacent to the first lateral edge of the supporting element. The second coil structure is disposed adjacent to the second lateral edge of the supporting element. The first coil structure and the second coil structure are configured to generate multi-directional side radiation.

### BRIEF DESCRIPTION OF DRAWINGS

The invention can be more fully understood by reading the subsequent detailed description and examples with references made to the accompanying drawings, wherein:

FIG. 1A is a front view of an antenna structure according to an embodiment of the invention;

FIG. 1B is a side view of an antenna structure according to an embodiment of the invention;

FIG. 2 is a front view of an antenna structure according to an embodiment of the invention;

FIG. 3 is a front view of an antenna structure according to an embodiment of the invention;

FIG. 4 is a front view of an antenna structure according to an embodiment of the invention;

FIG. 5 is a front view of an antenna structure according to an embodiment of the invention;

FIG. 6 is a front view of an antenna structure according to an embodiment of the invention;

FIG. 7A is a front view of an antenna structure according to an embodiment of the invention;

FIG. 7B is a back view of an antenna structure according to an embodiment of the invention;

FIG. 8A is a front view of an antenna structure according to an embodiment of the invention;

FIG. 8B is a back view of an antenna structure according to an embodiment of the invention;

FIG. 9 is a front view of an antenna structure according to an embodiment of the invention; and

FIG. 10 is a front view of an antenna structure according to an embodiment of the invention.

### DETAILED DESCRIPTION OF THE INVENTION

In order to illustrate the purposes, features and advantages of the invention, the embodiments and figures of the invention are shown in detail as follows.

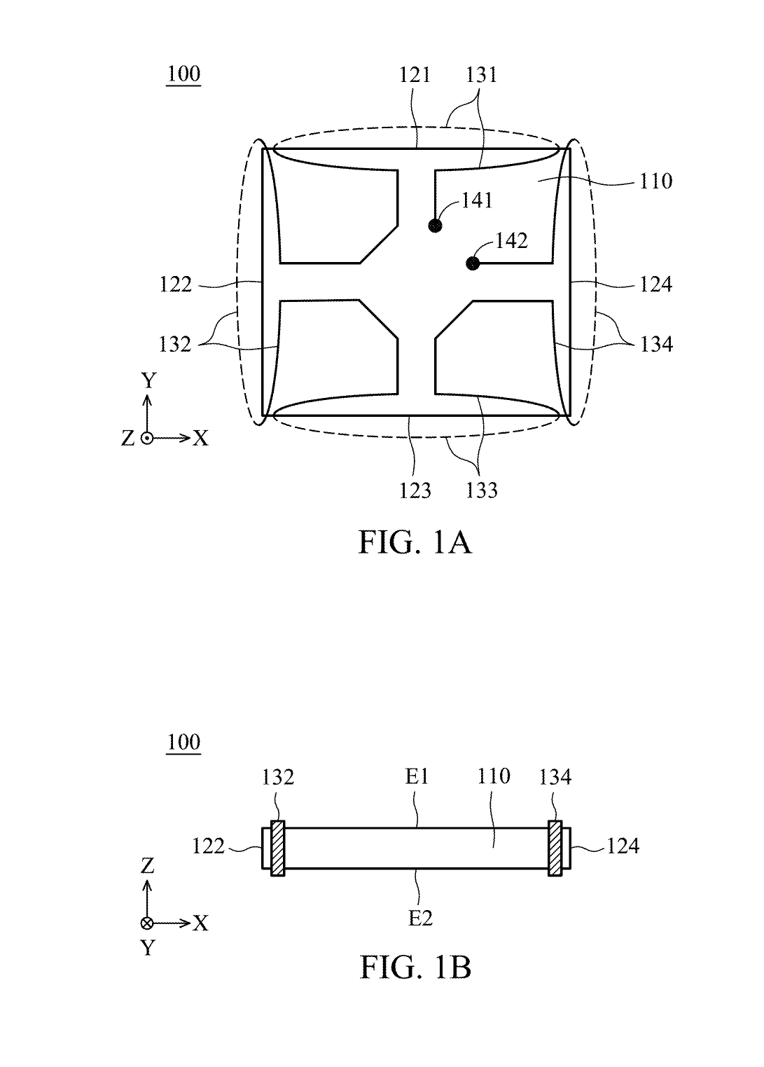

FIG. 1A is a front view of an antenna structure 100 according to an embodiment of the invention. FIG. 1B is a side view of the antenna structure 100 according to an embodiment of the invention. The antenna structure 100 is applicable to a mobile device, such as a smartphone, a tablet computer, or a notebook computer. In some embodiments, the antenna structure 100 operates in an NFC (Near Field Communication) frequency band. The antenna structure 100 may include a supporting element 110, a first coil structure 131, a second coil structure 132, a third coil structure 133, and a fourth coil structure 134. In the embodiments shown in FIG. 1A and FIG. 1B, the supporting element 110 is substantially a rectangular thin plate. Additionally, in some embodiments, the supporting element 110 can be a square thin plate, a trapezoidal thin plate, a parallelogram thin plate, or a circular thin plate. If the thickness of the supporting element 110 is greater than or equal to 3 mm, the supporting element 110 may be made of a nonconductive material. If the thickness of the supporting element 110 is smaller than 3 mm, the supporting element 110 may be made of a magnetic conductive material such as ferrite. The antenna structure 100 may further include a first feeding pad 141 and a second feeding pad 142. The first feeding pad 141 is being used as a first terminal point of the antenna structure 100. The second feeding pad 142 is being used as a second terminal point of the antenna structure 100. The first terminal point and the second terminal point of the antenna structure 100 may be respectively coupled to a positive electrode and a negative electrode of a signal source (not shown), such that the antenna structure 100 is excited by the signal source. Furthermore, the first feeding pad 141 and/or the second feeding pad 142 may be coupled through a matching circuit to the signal source. The matching circuit may include one or more capacitors and/or one or more inductors (not shown), so as to provide an appropriate effective resonant length for the antenna structure 100.

The supporting element 110 has an upper surface E1, a lower surface E2, and a plurality of lateral edges 121, 122, 123, and 124. The lateral edges 121, 122, 123, and 124 are all positioned between the upper surface E1 and the lower surface E2. The first coil structure 131 is disposed adjacent to a first lateral edge 121 of the supporting element 110. The second coil structure 132 is disposed adjacent to a second lateral edge 122 of the supporting element 110. The third coil structure 133 is disposed adjacent to a third lateral edge 123 of the supporting element 110. The fourth coil structure 134 is disposed adjacent to a fourth lateral edge 124 of the supporting element 110. Each of the first coil structure 131, the second coil structure 132, the third coil structure 133, and the fourth coil structure 134 has one or more coil turns. It should be understood that the solid lines in each figure represent the metal conductive lines disposed on the upper surface E1 of the supporting element 110, and the dashed lines in each figure represent the metal conductive lines disposed on the lower surface E2 of the supporting element 110. With such a design, the main beam of the first coil structure 131 is arranged toward a direction along the +Y axis, the main beam of the second coil structure 132 is arranged toward a direction along the −X axis, the main beam of the third coil structure 133 is arranged toward a direction along the −Y axis, and the main beam of the fourth coil structure 134 is arranged toward a direction along the +X axis. Accordingly, the first coil structure 131, the second coil structure 132, the third coil structure 133, and the fourth coil structure 134 of the antenna structure 100 are configured to generate multi-directional side radiation, and therefore the antenna structure 100 can support multi-point detections.

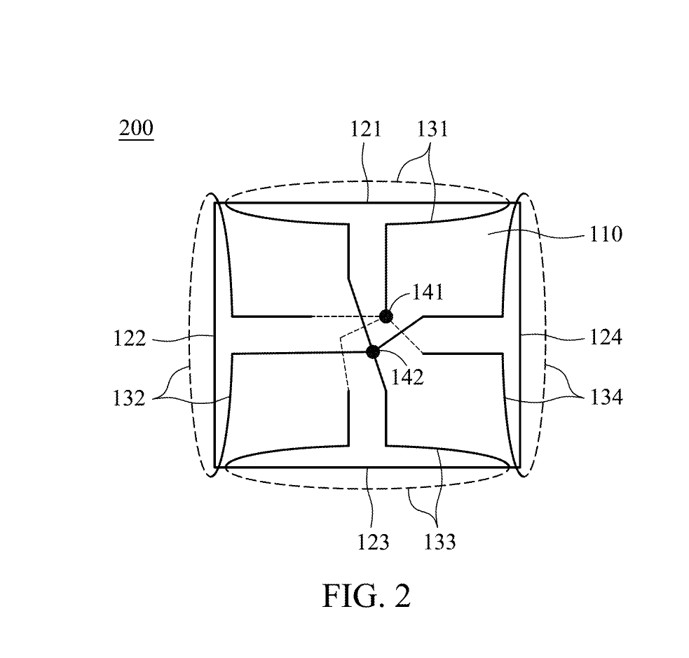

In the embodiment of FIG. 1A and FIG. 1B, the first coil structure 131, the second coil structure 132, the third coil structure 133, and the fourth coil structure 134 are coupled in series between the first feeding pad 141 and the second feeding pad 142. That is, a current path is formed from the first feeding pad 141 through the first coil structure 131, the second coil structure 132, the third coil structure 133, and the fourth coil structure 134 to the second feeding pad 142. However, the invention is not limited to the above. FIG. 2 is a front view of an antenna structure 200 according to another embodiment of the invention. In the embodiment of FIG. 2, the first coil structure 131, the second coil structure 132, the third coil structure 133, and the fourth coil structure 134 are coupled in parallel between the first feeding pad 141 and the second feeding pad 142. That is, each of the first coil structure 131, the second coil structure 132, the third coil structure 133, and the fourth coil structure 134 has two ends respectively coupled to the first feeding pad 141 and the second feeding pad 142.

The antenna structures of the invention may be classified into a serial type (as shown in FIG. 1A) and an array type (as shown in FIG. 2). The two types of antenna structures both support multi-directional side radiation. A conventional NFC antenna usually merely supports front and back signal transmission (as shown in FIG. 1B toward the +Z axis and the −Z axis). The invention overcomes the drawbacks of the conventional design, and it can achieve almost omnidirectional radiation and multi-point detections that are better than the prior art.

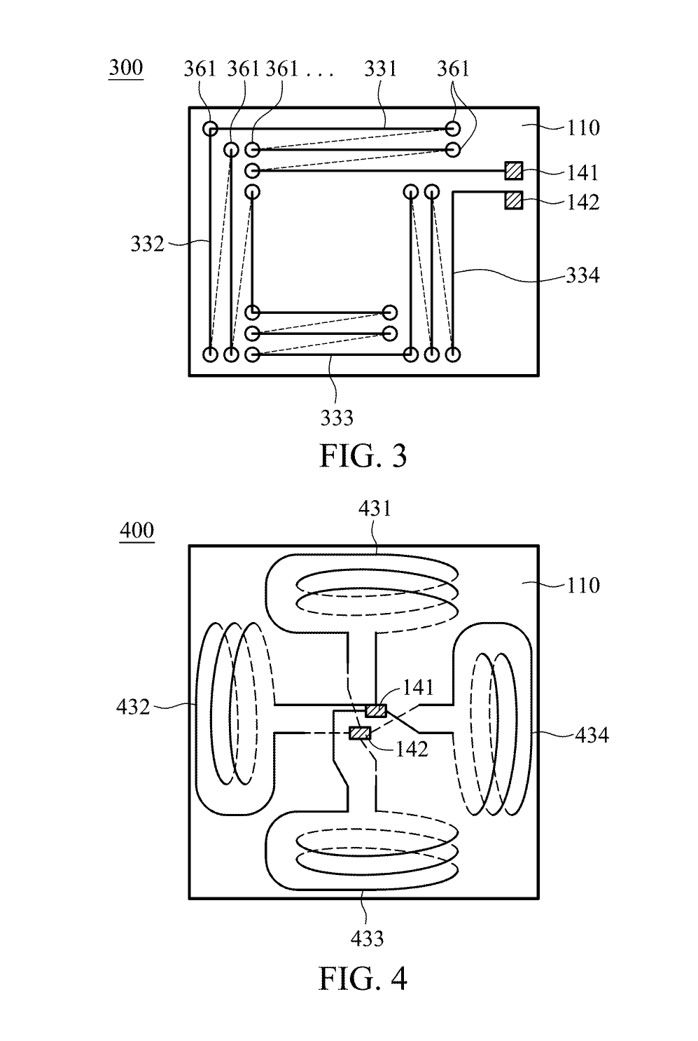

FIG. 3 is a front view of an antenna structure 300 according to an embodiment of the invention. FIG. 3 is similar to FIG. 1A (the serial type). In the embodiment of FIG. 3, the antenna structure 300 includes a supporting element 110, a first coil structure 331, a second coil structure 332, a third coil structure 333, a fourth coil structure 334, a first feeding pad 141, and a second feeding pad 142. The hollow circles in the figure represent metal connection elements 361 penetrating the support element 110. These metal connection elements 361 are configured to connect the metal conductive lines disposed on the upper surface E1 of the supporting element 110 (i.e., the solid straight lines) to the other metal conductive lines disposed on the lower surface E2 of the supporting element 110 (i.e., the dashed straight lines), thereby forming the above coil structures. Each of the above coil structures has two or more coil turns, so as to enhance the strength of each side radiation. Other features of the antenna structure 300 of FIG. 3 are similar to those of the antenna structure 100 of FIG. 1A and FIG. 1B. As a result, these embodiments can achieve similar levels of performance.

FIG. 4 is a front view of an antenna structure 400 according to an embodiment of the invention. FIG. 4 is similar to FIG. 2 (the array type). In the embodiment of FIG. 4, the antenna structure 400 includes a supporting element 110, a first coil structure 431, a second coil structure 432, a third coil structure 433, a fourth coil structure 434, a first feeding pad 141, and a second feeding pad 142. Each of the above coil structures has two or more coil turns, so as to enhance the strength of each side radiation. Other features of the antenna structure 400 of FIG. 4 are similar to those of the antenna structure 200 of FIG. 2. As a result, these embodiments can achieve similar levels of performance.

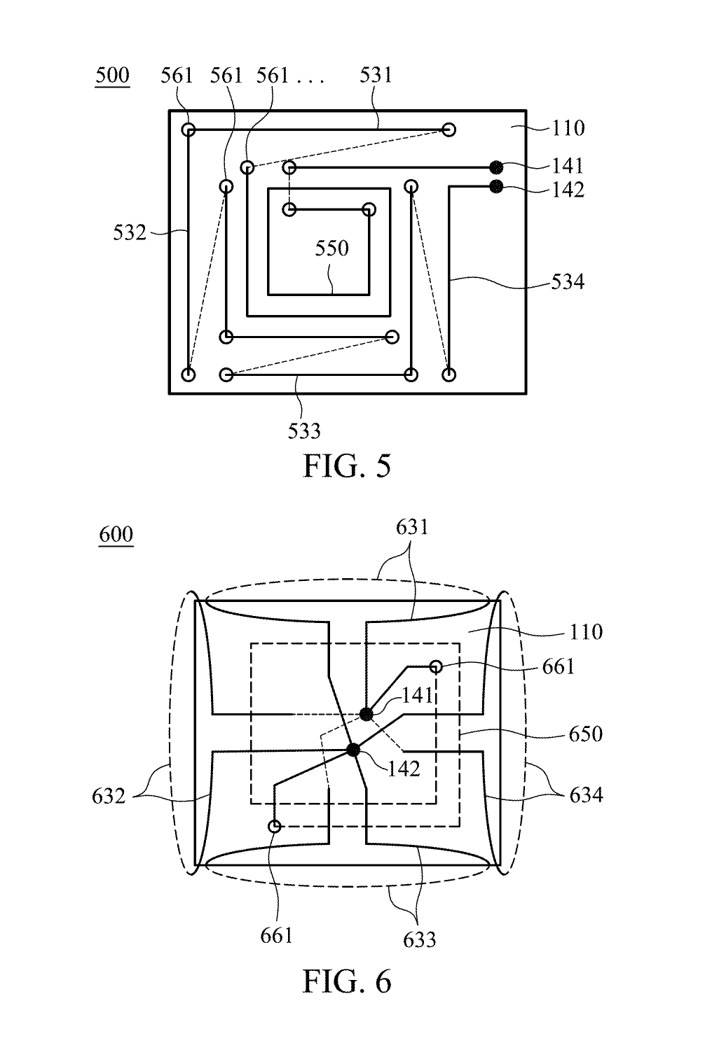

FIG. 5 is a front view of an antenna structure 500 according to an embodiment of the invention. FIG. 5 is similar to FIG. 1A (the serial type). In the embodiment of FIG. 5, the antenna structure 500 includes a supporting element 110, a first coil structure 531, a second coil structure 532, a third coil structure 533, a fourth coil structure 534, a first feeding pad 141, a second feeding pad 142, and a central coil structure 550. The hollow circles in the figure represent metal connection elements 561 penetrating the support element 110. These metal connection elements 561 are configured to connect the metal conductive lines disposed on the upper surface E1 of the supporting element 110 (i.e., the solid straight lines) to the other metal conductive lines disposed on the lower surface E2 of the supporting element 110 (i.e., the dashed straight lines), thereby forming the above coil structures. The central coil structure 550 may be coupled between any two elements selected among the first feeding pad 141, the first coil structure 531, the second coil structure 532, the third coil structure 533, the fourth coil structure 534, and the second feeding pad 142 (coupled in series). The first coil structure 531, the second coil structure 532, the third coil structure 533, and the fourth coil structure 534 are configured to generate side radiation. The central coil structure 550 is disposed at a central region of the supporting element 110, and has one or more coil turns. The central coil structure 550 is configured to generate front and back radiation. With such a combination of antenna designs, the antenna structure 500 can generate front, back, and side multi-directional radiation, which is almost equivalent to omnidirectional radiation. Other features of the antenna structure 500 of FIG. 5 are similar to those of the antenna structure 100 of FIG. 1A and FIG. 1B. As a result, these embodiments can achieve similar levels of performance.

FIG. 6 is a front view of an antenna structure 600 according to an embodiment of the invention. FIG. 6 is similar to FIG. 2 (the array type). In the embodiment of FIG. 6, the antenna structure 600 includes a supporting element 110, a first coil structure 631, a second coil structure 632, a third coil structure 633, a fourth coil structure 634, a first feeding pad 141, a second feeding pad 142, and a central coil structure 650. The first coil structure 631, the second coil structure 632, the third coil structure 633, and the fourth coil structure 634 are configured to generate side radiation. The central coil structure 650 has two ends respectively coupled to the first feeding pad 141 and the second feeding pad 142 (coupled in parallel). The central coil structure 650 is disposed at a central region of the supporting element 110, and has one or more coil turns. The central coil structure 650 is configured to generate front and back radiation. With such a combination of antenna designs, the antenna structure 600 can generate front, back, and side multi-directional radiation, which is almost equivalent to omnidirectional radiation. Other features of the antenna structure 600 of FIG. 6 are similar to those of the antenna structure 200 of FIG. 2. As a result, these embodiments can achieve similar levels of performance.

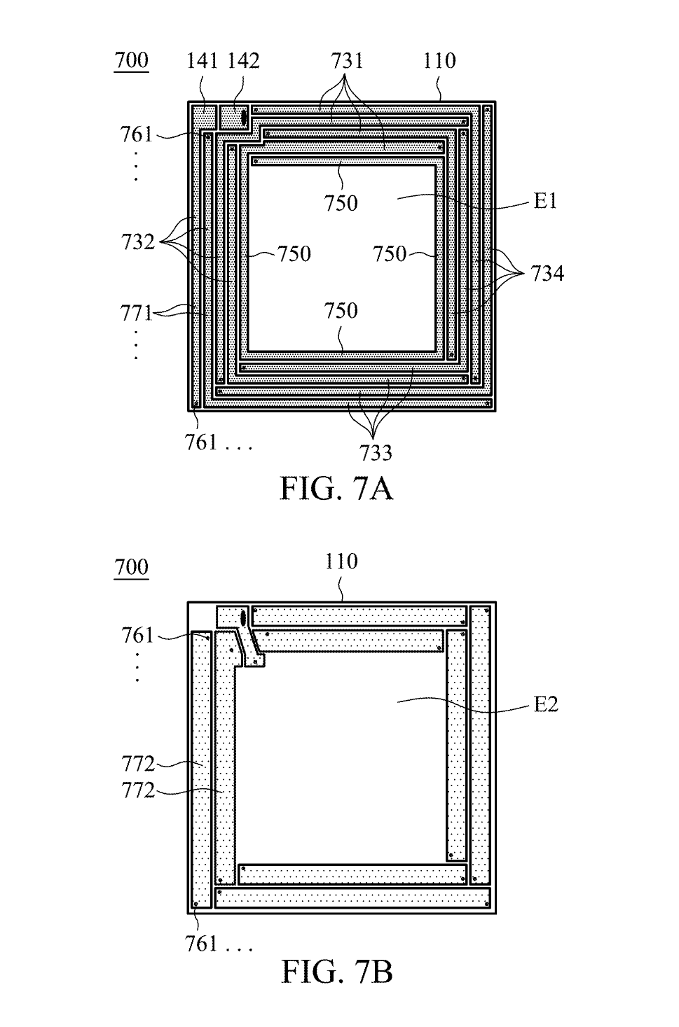

FIG. 7A is a front view of an antenna structure 700 according to an embodiment of the invention. FIG. 7B is a back view of the antenna structure 700 according to an embodiment of the invention. FIG. 7A and FIG. 7B are similar to FIG. 1A (the serial type). In the embodiment of FIG. 7A and FIG. 7B, the antenna structure 700 includes a supporting element 110, a first coil structure 731, a second coil structure 732, a third coil structure 733, a fourth coil structure 734, a first feeding pad 141, a second feeding pad 142, and a central coil structure 750. Each of the first coil structure 731, the second coil structure 732, the third coil structure 733, the fourth coil structure 734, and the central coil structure 750 includes one or more first metal conductive lines 771, one or more second metal conductive lines 772, and metal connection elements 761. The first metal conductive lines 771 are disposed on an upper surface E1 of the supporting element 110. The second metal conductive lines 772 are disposed on a lower surface E2 of the supporting element 110. The width of each second metal conductive line 772 is about two times that of each first metal conductive line 771. In some embodiments, the first metal conductive lines 771 and the second metal conductive lines 772 substantially have straight-line shapes with uniform widths. In alternative embodiments, the first metal conductive lines 771 and the second metal conductive lines 772 substantially have straight-line shapes with non-uniform widths. The spacing between any two adjacent first metal conductive lines 771 is at least 0.05 mm, and the spacing between any two adjacent second metal conductive lines 772 is at least 0.05 mm. The metal connection elements 761 penetrate the supporting element 110. For example, the supporting element 110 may have multiple via holes, and the metal connection elements 761 are respectively formed in the via holes. The metal connection elements 761 further connect the first metal conductive lines 771 to the second metal conductive lines 772, respectively, such that the first metal conductive lines 771, the metal connection elements 761, and the second metal conductive lines 772 form the above coil structures surrounding the supporting element 110. The first coil structure 731, the second coil structure 732, the third coil structure 733, and the fourth coil structure 734 are configured to generate side radiation. The central coil structure 750 is configured to generate front and back radiation. With such a combination of antenna designs, the antenna structure 700 can generate front, back, and side multi-directional radiation, which is almost equivalent to omnidirectional radiation. Other features of the antenna structure 700 of FIGS. 7A and 7B are similar to those of the antenna structure 100 of FIG. 1A and FIG. 1B. As a result, these embodiments can achieve similar levels of performance.

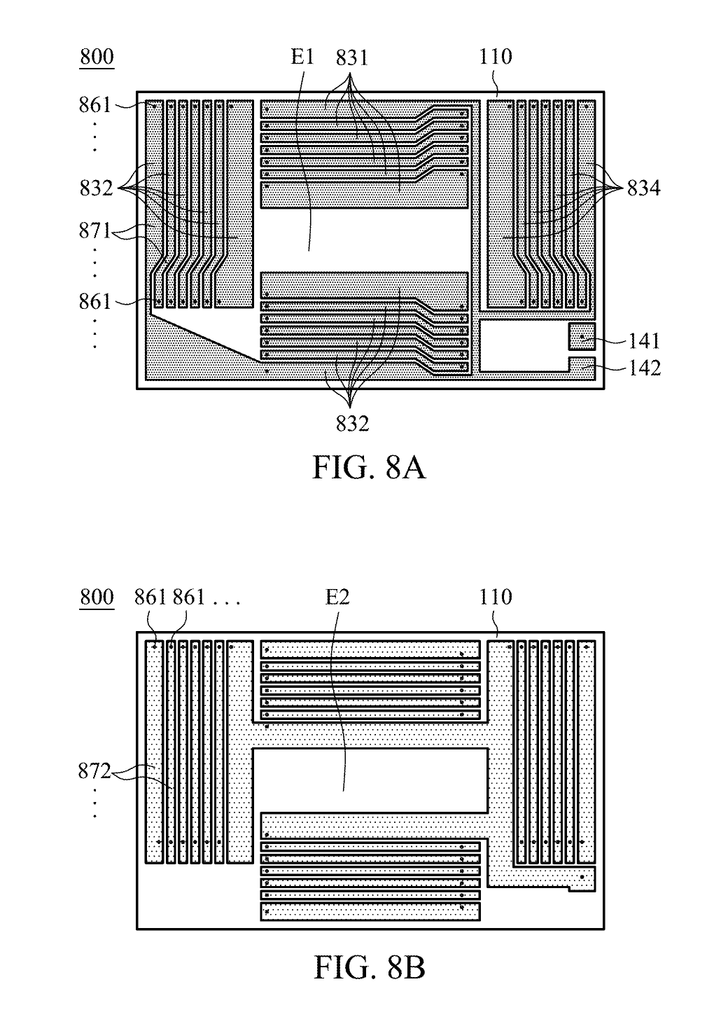

FIG. 8A is a front view of an antenna structure 800 according to an embodiment of the invention. FIG. 8B is a back view of the antenna structure 800 according to an embodiment of the invention. FIG. 8A and FIG. 8B are similar to FIG. 2 (the array type). In the embodiment of FIG. 8A and FIG. 8B, the antenna structure 800 includes a supporting element 110, a first coil structure 831, a second coil structure 832, a third coil structure 833, a fourth coil structure 834, a first feeding pad 141, and a second feeding pad 142. Each of the first coil structure 831, the second coil structure 832, the third coil structure 833, and the fourth coil structure 834 includes one or more first metal conductive lines 871, one or more second metal conductive lines 872, and metal connection elements 861. The first metal conductive lines 871 are disposed on an upper surface E1 of the supporting element 110. The second metal conductive lines 872 are disposed on a lower surface E2 of the supporting element 110. The spacing between any two adjacent first metal conductive lines 871 is at least 0.05 mm, and the spacing between any two adjacent second metal conductive lines 872 is at least 0.05 mm. The metal connection elements 861 penetrate the supporting element 110. The supporting element 110 may have multiple via holes, and the metal connection elements 861 are respectively formed in the via holes. The metal connection elements 861 further connect the first metal conductive lines 871 to the second metal conductive lines 872, respectively, such that the first metal conductive lines 871, the metal connection elements 861, and the second metal conductive lines 872 form the above coil structures surrounding the supporting element 110. More specifically, the first metal conductive lines 871 have vertical projections on the lower surface E2 of the supporting element 110, and the vertical projections are not parallel to at least a portion of the second metal conductive lines 872, such that these components can interleave with each other and form the above coil structures. For example, an angle θ between each of the vertical projections of a line connecting the two ends of the first metal conductive lines 871 and at least a portion of the second metal conductive lines 872 is from 0 to 45 degrees. In some embodiments, the angle θ is from 10 to 15 degrees. With such a design, the antenna structure 800 can generate multi-directional side radiation. In alternative embodiments, the antenna structure 800 further includes a central coil structure, so as to achieve almost omnidirectional radiation. Other features of the antenna structure 800 of FIG. 8A and FIG. 8B are similar to those of the antenna structure 200 of FIG. 2. As a result, these embodiments can achieve similar levels of performance.

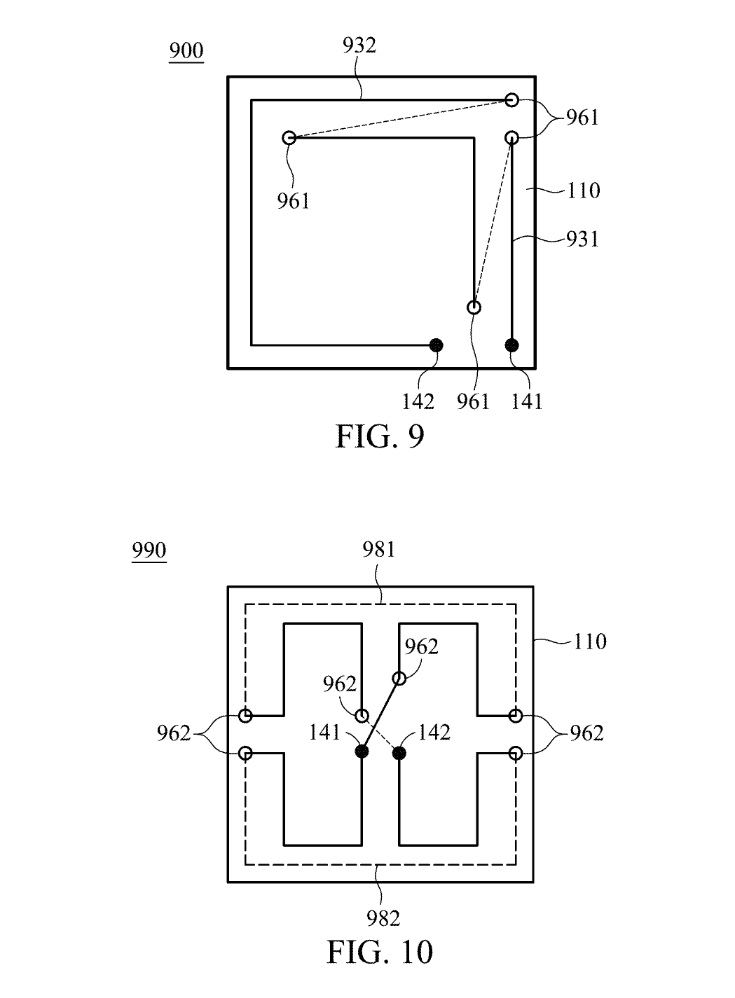

FIG. 9 is a front view of an antenna structure 900 according to an embodiment of the invention. FIG. 9 is similar to FIG. 1A (the serial type). In the embodiment of FIG. 9, the antenna structure 900 includes a supporting element 110, a first coil structure 931, a second coil structure 932, a first feeding pad 141, and a second feeding pad 142. The antenna structure 900 is considered as a simplified version of the antenna structure 100 of FIG. 1A and FIG. 1B. The antenna structure 900 includes at least two coil structures, so as to generate at least two-directional side radiation. Other features of the antenna structure 900 of FIG. 9 are similar to those of the antenna structure 100 of FIGS. 1A and 1B. As a result, these embodiments can achieve similar levels of performance.

FIG. 10 is a front view of an antenna structure 990 according to an embodiment of the invention. FIG. 10 is similar to FIG. 2 (the array type). In the embodiment of FIG. 10, the antenna structure 990 includes a supporting element 110, a first coil structure 981, a second coil structure 982, a first feeding pad 141, and a second feeding pad 142. The antenna structure 990 is considered as a simplified one of the antenna structure 200 of FIG. 2. The antenna structure 990 includes only at least two coil structures, so as to generate at least two-directional side radiation. Other features of the antenna structure 990 of FIG. 10 are similar to those of the antenna structure 200 of FIG. 2. As a result, these embodiments can achieve similar levels of performance.

In comparison to prior arts, the invention has at least the following advantages: (1) providing almost omnidirectional radiation, (2) reducing the total thickness by integrating the antenna structure with the supporting element, and (3) decreasing the total cost of manufacturing the antenna structure. Therefore, the invention is suitable for application in a variety of small-size mobile communication devices.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure, comprising:
a supporting element, having an upper surface, a lower surface, a first lateral edge, and a second lateral edge positioned between the upper surface and the lower surface;
a first coil structure, disposed adjacent to the first lateral edge of the supporting element; and
a second coil structure, disposed adjacent to the second lateral edge of the supporting element;
wherein the first coil structure and the second coil structure are configured to generate multi-directional side radiation.

2. The antenna structure as claimed in claim 1, wherein the supporting element is substantially a rectangular thin plate or a square thin plate.

3. The antenna structure as claimed in claim 1, wherein a thickness of the supporting element is greater than or equal to 3 mm, and the supporting element is made of nonconductive material.

4. The antenna structure as claimed in claim 1, wherein a thickness of the supporting element is smaller than 3 mm, and the supporting element is made of magnetic conductive material.

5. The antenna structure as claimed in claim 4, wherein the magnetic conductive material is ferrite.

6. The antenna structure as claimed in claim 1, further comprising:
a first feeding pad disposed in the antenna structure and being used as a first terminal point of the antenna structure; and
a second feeding pad disposed in the antenna structure and being used as a second terminal point of the antenna structure.

7. The antenna structure as claimed in claim 6, wherein the supporting element further comprises a third lateral edge and a fourth lateral edge positioned between the upper surface and the lower surface, and the antenna structure further comprises:
a third coil structure, disposed adjacent to the third lateral edge of the supporting element; and
a fourth coil structure, disposed adjacent to the fourth lateral edge of the supporting element;
wherein the third coil structure and the fourth coil structure are configured to generate the multi-directional side radiation.

8. The antenna structure as claimed in claim 7, wherein the first coil structure, the second coil structure, the third coil structure, and the fourth coil structure are coupled in series between the first feeding pad and the second feeding pad.

9. The antenna structure as claimed in claim 8, wherein a current path is formed from the first feeding pad through the first coil structure, the second coil structure, the third coil structure, and the fourth coil structure to the second feeding pad.

10. The antenna structure as claimed in claim 7, wherein the first coil structure, the second coil structure, the third coil structure, and the fourth coil structure are coupled in parallel between the first feeding pad and the second feeding pad.

11. The antenna structure as claimed in claim 10, wherein each of the first coil structure, the second coil structure, the third coil structure, and the fourth coil structure has two ends respectively coupled to the first feeding pad and the second feeding pad.

12. The antenna structure as claimed in claim 7, further comprising:
a central coil structure, disposed at a central region of the supporting element, wherein the central coil structure is configured to generate front and back radiation.

13. The antenna structure as claimed in claim 12, wherein the central coil structure is coupled between any two elements selected among the first feeding pad, the first coil structure, the second coil structure, the third coil structure, the fourth coil structure, and the second feeding pad.

14. The antenna structure as claimed in claim 12, wherein the central coil structure has two ends respectively coupled to the first feeding pad and the second feeding pad.

15. The antenna structure as claimed in claim 7, wherein each of the first coil structure, the second coil structure, the third coil structure, and the fourth coil structure has one or more coil turns.

16. The antenna structure as claimed in claim 7, wherein each of the first coil structure, the second coil structure, the third coil structure, and the fourth coil structure comprises:
one or more first metal conductive lines, disposed on the upper surface of the supporting element;
one or more second metal conductive lines, disposed on the lower surface of the supporting element; and
a plurality of metal connection elements, penetrating the supporting element, wherein the metal connection elements connect the first metal conductive lines to the second metal conductive lines, respectively.

17. The antenna structure as claimed in claim 16, wherein the first metal conductive lines and the second metal conductive lines substantially have straight-line shapes.

18. The antenna structure as claimed in claim 16, wherein the first metal conductive lines have one or more vertical projections on the lower surface of the supporting element, and the vertical projections are not parallel to at least a portion of the second metal conductive lines.

19. The antenna structure as claimed in claim 18, wherein an angle between each of the vertical projections and the portion of the second metal conductive lines is from 0 to 45 degrees.

20. The antenna structure as claimed in claim 16, wherein spacing between any two adjacent first metal conductive lines is at least 0.05 mm, and spacing between any two adjacent second metal conductive lines is at least 0.05 mm.
